(19) United States
(12) Patent Application Publication
(10) Pub. No.: US 2010/0149079 A1
(43) Pub. Date: Jun. 17, 2010

(54) Display device, method of driving display device, and electronic apparatus

(75) Inventors: Junichi Yamashita, Tokyo (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/591,441

(22) Filed: Nov. 19, 2009

(30) Foreign Application Priority Data
Dec. 15, 2008 (JP) 2008-317772

(51) Int. Cl. G09G 3/36

(52) U.S. Cl. 345/87

(57) ABSTRACT

A display device includes: a screen section; a drive section; and a signal processing section. The screen section includes scanning lines arranged in rows, signal lines arranged in columns, and pixel circuits arranged in a matrix. The drive section includes a scanner which supplies a control signal to the scanning lines, and a driver which supplies a video signal to the signal lines. Each of the pixel circuits includes a light-emitting element, a light-receiving element, and a drive transistor. The drive transistor outputs a drive current in response to the video signal and outputs a correction current in response to a luminance signal. The light-emitting element emits light in accordance with the drive current. The light-receiving element outputs the luminance signal in accordance with the light-emission. The signal processing section corrects the video signal in accordance with the correction current and supplies the corrected video signal to the driver.

### BACKGROUND OF THE INVENTION

1. Field of the Invention

The present invention relates to a display device which current-drives a light-emitting element provided in each pixel to display an image, and to a method of driving a display device. Further, the present invention relates to an electronic apparatus using the display device. In particular, the present invention relates to a method of driving a so-called active-matrix display device which controls the amount of current flowing in a light-emitting element, such as an organic EL element or the like, by an insulating gate field effect transistor provided in each pixel circuit.

2. Description of the Related Art

In a display device, for example, a liquid crystal display or the like, a plurality of liquid crystal pixels are arranged in a matrix. Such a display device controls the transmission or reflection intensity of incident light for each pixel in accordance with image information to be displayed, thereby displaying an image. This is also true for an organic EL display using organic EL elements, or the like. However, the organic EL elements are self-luminous elements, unlike the liquid crystal pixels. As a result, the organic EL display has several advantages over the liquid crystal display. Such advantages include high image visibility, no need for a backlight, high response speed, and the like. Further, the luminance level (grayscale) of each light-emitting element can be controlled by the value of current flowing through the same element. Thus, the organic EL display is a so-called current-controlled device, and significantly differs from voltage-controlled devices, such as liquid crystal displays and the like.

Similarly to the liquid crystal display, the kinds of drive systems of the organic EL display include a simple-matrix system and an active-matrix system. The simple-matrix system has a simple structure but involves problems, such as difficulty in achieving a large and high-definition display or the like. Accordingly, the active-matrix system is currently being developed more actively. In the active matrix system, the current that flows through a light-emitting element in each pixel circuit is controlled by an active element (typically, a thin film transistor (TFT)) provided in the pixel circuit. Examples of related art are JP-A-2003-255856, JP-A-2003-271095, JP-A-2004-133240, JP-A-2004-029791, JP-A-2004-093682, JP-A-2006-215213, and JP-A-2007-310311.

### SUMMARY OF THE INVENTION

A known display device basically includes a screen section and a drive section. The screen section includes scanning lines arranged in rows, signal lines arranged in columns, and pixels disposed at intersections of the scanning lines and the signal lines and arranged in a matrix. The drive section is disposed around the screen section, and has a scanner which sequentially supplies a control signal to the scanning lines, and a driver which supplies a video signal to the signal lines. Each of the pixels of the screen section receives a video signal from the corresponding signal line when being selected in response to a control signal supplied from the corresponding scanning line and emits light in response to the received video signal.

Each pixel has, for example, an organic EL device as a light-emitting element. The current/luminance characteristic of the light-emitting element tends to be deteriorated over time. Accordingly, the pixels of the organic EL display undergo degradation in luminance as time passes. The degree of degradation in luminance depends on the cumulative light-emission time of each pixel. When the cumulative light-emission time differs between the pixels on the screen, luminance irregularity may occur, and an image quality defect, so-called “burn-in”, may occur.

Thus, it is desirable to provide a display device which can compensate for the degradation in luminance of pixels.

An embodiment of the invention provides a display device including a screen section, a drive section, and a signal processing section. The screen section includes scanning lines arranged in rows, signal lines arranged in columns, and pixel circuits arranged in a matrix. The drive section includes a scanner which supplies a control signal to the scanning lines, and a driver which supplies a video signal to the signal lines. Each of the pixel circuits includes a light-emitting element, a light-receiving element, and a drive transistor. The drive transistor outputs a drive current in response to the video signal and outputs a correction current in response to a luminance signal. The light-emitting element emits light in accordance with the drive current, and the light-receiving element outputs the luminance signal in accordance with the light-emission. The signal processing section corrects the video signal in accordance with the correction current and supplies the corrected video signal to the driver.

The drive transistor may have a gate to which the video signal and the luminance signal are applied. The light-emitting element may be connected to one of the drain and source of the drive transistor, and the light-receiving element may be connected to the gate of the drive transistor. The pixel circuit may further include a first transistor connected to the gate of the drive transistor, a second transistor connected to one of the drain and source of the drive transistor, and a capacitor connected between one of the drain and source of the drive transistor and the gate of the drive transistor. In one embodiment, the pixel circuit may further include a third transistor connected between the drive transistor and the light-emitting element, and a fourth transistor connected between a signal line of a pixel circuit adjacent to the pixel circuit and the light-emitting element of the pixel circuit. In another embodiment, the pixel circuit may further include a third transistor connected between the drive transistor and the light-emitting element, and a fourth transistor connected between the driver and the light-emitting element of the pixel circuit. The drive transistor of the pixel circuit may operate during a light-emission period and a light-reception period. The drive transistor may output a drive current during the light-emission period and may output the correction current in accordance with the light-emission of a different pixel circuit during the light-reception period. The different pixel circuit may be .a pixel circuit adjacent to the pixel circuit. The drive transistor of the pixel circuit may operate during a light-emission period and a light-reception period. The drive transistor may output the drive current during the light-emission period and may output the correction current in accordance with the light-emission of the pixel circuit during the light-reception period. In this case, during the light-reception period, the light-emitting element of the pixel circuit may emit light due to a current supplied from the driver, and the light-receiving element of the pixel circuit may output the luminance signal in accordance with the light-emission. The drive transistor may supply the correction current to the relevant signal line, and the signal processing section may correct the video signal in accordance with the correction current and supply the corrected video signal to the driver of the drive section. The signal processing section may compare a first correction current output from the drive transistor during a first period with a second correction current output from the drive transistor during a second period later than the first period, may correct the video signal in accordance with the comparison result, and may supply the corrected video signal to the driver.

According to the embodiments of the invention, the signal processing section corrects the video signal in response to the luminance signal output from the light-receiving element of each pixel and supplies the corrected video signal to the driver of the drive section. Therefore, the degradation in luminance of the pixels can be compensated by the correction of the video signal, and as a result, image quality defects, such as “burn-in” and the like, which are inherent in the related art can be suppressed.

In particular, according to the embodiments of the invention, the light-emitting element and the light-receiving element are disposed together in each pixel. Then, a transistor for driving the light-emitting element and a transistor for driving the light-receiving element are used in common, so the light-emitting element and the light-receiving element are driven in a time division manner by a single drive transistor. With this configuration, the circuit configuration of the pixel can be simplified, and an increase in the number of auxiliary circuit elements due to the addition of the light-emitting element can be minimized. Therefore, with a minimum increase in the number of elements of the pixel circuit, degradation in luminance efficiency of the light-emitting element can be detected and corrected. The correction of the degradation in luminance in terms of pixels ensures a high-quality display device.

### BRIEF DESCRIPTION OF THE DRAWINGS

FIG. 1 is a block diagram showing a panel of a display device according to a reference example.

FIG. 2 is a circuit diagram of each pixel provided in the panel of FIG. 1.

FIG. 3 is a timing chart illustrating the operation of the reference example.

FIG. 4 is a timing chart illustrating the operation of the reference example.

FIG. 5 is a circuit diagram showing a reference example of a light-receiving circuit.

FIG. 6 is a circuit diagram showing a panel of a display device according to a first embodiment of the invention.

FIG. 7 is a circuit diagram illustrating the operation of the first embodiment.

FIG. 8 is a circuit diagram illustrating the operation of the first embodiment.

FIG. 9 is a circuit diagram illustrating the operation of the first embodiment.

FIG. 10 is a block diagram showing the overall configuration of the first embodiment.

FIG. 11 is a schematic view showing a burn-in phenomenon.

FIG. 12 is a schematic view showing dot-sequential scanning for light-emission luminance detection of the first embodiment.

FIG. 13 is a schematic view illustrating the operation of the first embodiment.

FIG. 14 is a diagram showing the configuration of a panel of a display device according to a second embodiment of the invention.

FIG. 15 is a diagram showing the configuration of a panel of a display device according to a third embodiment of the invention.

FIG. 16 is a circuit diagram illustrating the operation of the third embodiment.

FIG. 17 is a diagram showing the configuration of a panel of a display device according to a fourth embodiment of the invention.

FIG. 18 is a circuit diagram illustrating the operation of the fourth embodiment.

FIG. 19 is a sectional view showing the device configuration of a display device according to an application of the invention.

FIG. 20 is a plan view showing the module configuration of a display device according to an application of the invention.

FIG. 21 is a perspective view showing a television set including a display device according to an application of the invention.

FIG. 22 is a perspective view showing a digital still camera including a display device according to an application of the invention.

FIG. 23 is a perspective view showing a notebook-type personal computer including a display device according to an application of the invention.

FIG. 24 is a schematic view showing a personal digital assistant including a display device according to an application of the invention.

FIG. 25 is a perspective view showing a video camera including a display device according to an application of the invention.

### DESCRIPTION OF PREFERRED EMBODIMENTS

Hereinafter, the best mode for carrying out the invention (hereinafter, referred to as an embodiment) will be described. The description will be made in the following sequence.

### REFERENCE EXAMPLE

### First Embodiment

### Second Embodiment

### Third Embodiment

### Fourth Embodiment

### Applications

### REFERENCES

### [Overall Configuration of Panel]

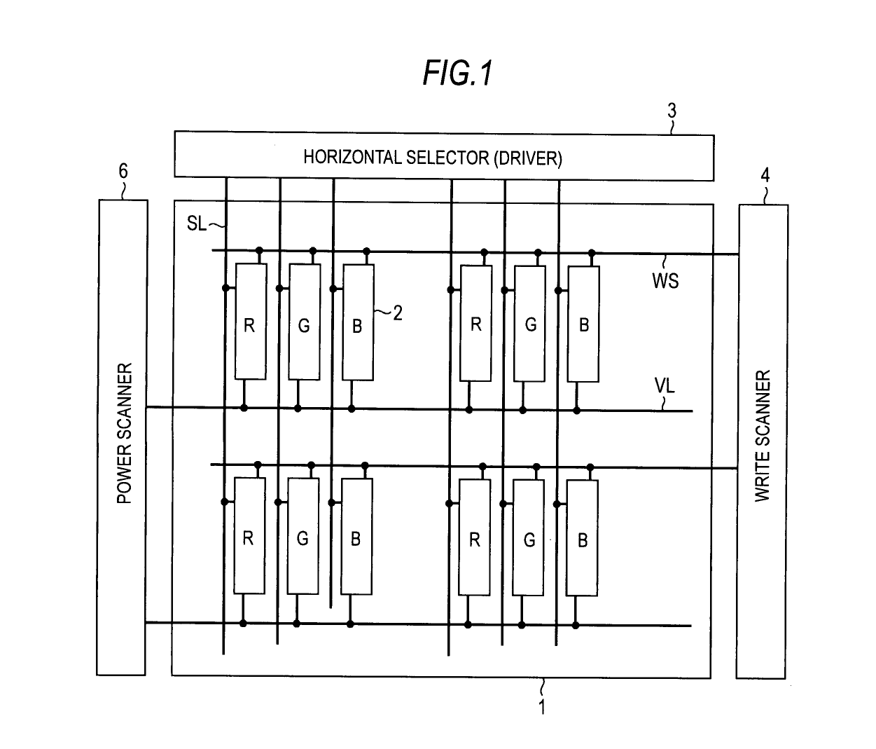

FIG. 1 shows the overall configuration of a panel which is a main portion of a display device according to a reference example. The display device has a structure before the invention is applied and will be first described as a reference example in order to make the background of the invention clear. As shown in FIG. 1, the display device includes a pixel array section 1 (screen section) and a drive section for driving the pixel array section 1. The pixel array section 1 includes scanning lines WS arranged in rows, signal lines SL arranged in columns, pixels 2 disposed at intersections of the scanning lines WS and the signal lines SL and arranged in a matrix, and power feed lines (power supply lines) VL disposed to correspond to the rows of pixels 2. In this example, one of the three primary colors of RGB is assigned to each pixel 2 for color display. However, the invention is not limited thereto but may be applied to a device for monochrome display. The drive section includes a write scanner 4, a power scanner 6, and a horizontal selector (signal driver) 3. The write scanner 4 sequentially supplies a control signal to the scanning lines WS so as to line-sequentially scan the pixels 2 in terms of rows. The power scanner 6 supplies a power supply voltage, which changes between a first potential and a second potential, to the power feed lines VL in matching with line-sequential scanning. The horizontal selector (signal driver) 3 which supplies a signal potential serving as a video signal and a reference potential to the signal lines SL arranged in columns in matching with line-sequential scanning.

### [Circuit Configuration of Pixel]

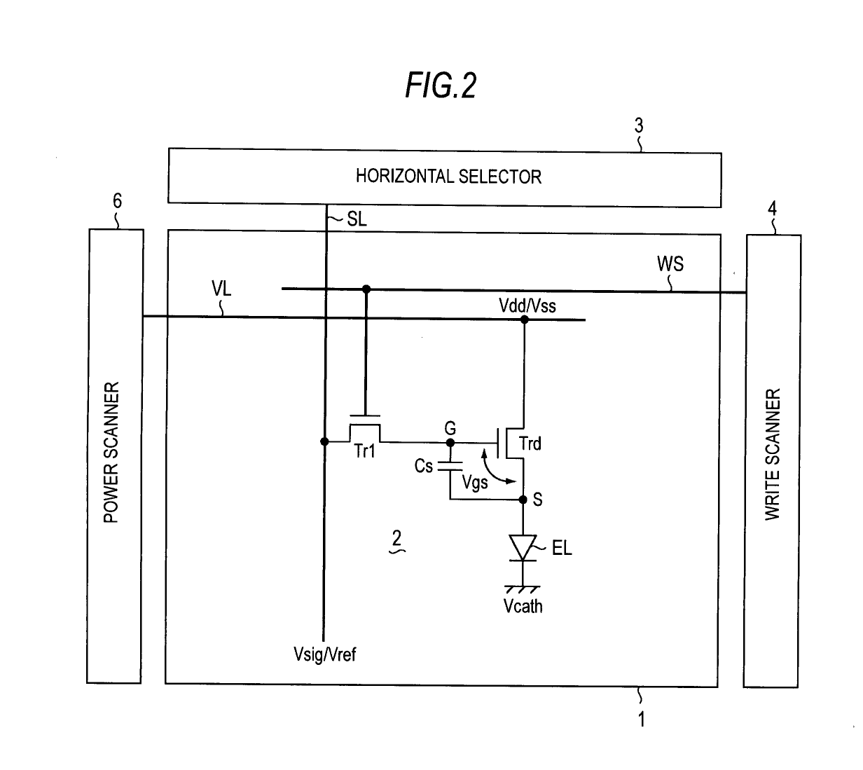

FIG. 2 is a circuit diagram showing the specific configuration and connection relationship of each pixel 2 provided in the display device of FIG. 1. As shown in FIG. 2, each pixel 2 includes a light-emitting element EL, such as an organic EL device or the like, a sampling transistor Tr1, a drive transistor Trd, and a pixel capacitor Cs. The sampling transistor Tr1 has a control terminal (gate) connected to the corresponding scanning line WS, one of a pair of current terminals (source and drain) connected to the corresponding signal line SL, and the other of a pair of current terminals connected to the control terminal (gate G) of the drive transistor Trd. The drive transistor Trd has one of a pair of current terminals (source S and drain) connected to the light-emitting element EL, and the other of a pair of current terminals connected to the corresponding power feed line VL. In this example, the drive transistor Trd is an N-channel transistor, and has a drain connected to the power feed line VL and a source S connected to the anode of the light-emitting element EL serving as an output node. The cathode of the light-emitting element EL is connected to a predetermined cathode potential Vcath. The pixel capacitor Cs is connected between the source S as one current terminal and the gate G as a control terminal of the drive transistor Trd.

With this configuration, the sampling transistor Tr1 conducts in response to a control signal from the scanning line WS, samples a signal potential supplied from the signal line SL, and holds the sampled signal potential in the pixel capacitor Cs. The drive transistor Trd is supplied with a current from the power feed line VL at a first potential (high potential Vdd) and supplies a drive current to the light-emitting element EL in accordance with the signal potential held in the pixel capacitor Cs. The write scanner 4 outputs a control signal having a predetermined pulse width to the control lines WS in order to bring the sampling transistor Tr1 into conduction when the signal line SL is at the signal potential so as to hold the signal potential in the pixel capacitor Cs and to apply the correction of the mobility μ of the drive transistor Trd to the signal potential. Thereafter, the drive transistor Trd supplies a drive current according to the signal potential Vsig written to the pixel capacitor Cs to the light-emitting element EL and enters a light-emission operation.

The pixel circuit 2 has a threshold voltage correction function, in addition to the above-described mobility correction function. That is, the power scanner 6 changes the power feed line VL from the first potential (high voltage Vdd) to a second potential (low potential Vss) at a first timing before the sampling transistor Tr1 samples the signal potential Vsig. Similarly, the write scanner 4 brings the sampling transistor Tr1 into conduction at a second timing before the sampling transistor Tr1 samples the signal potential Vsig, thus applying a reference potential Vref from the signal line SL to the gate G of the drive transistor Trd and setting the source S of the drive transistor Trd to the second potential (Vss). The power scanner 6 changes the power feed line VL from the second potential Vss to the first potential Vdd at a third timing after the second timing so as to hold a voltage corresponding to the threshold voltage Vth of the drive transistor Trd in the pixel capacitor Cs. With the threshold voltage correction function, the display device can cancel the influence of the threshold voltage Vth of the drive transistor Trd which varies for the pixels.

The pixel circuit 2 further has a bootstrap function. That is, the write scanner 4 removes the control signal from the scanning line WS when the signal potential Vsig is held in the pixel capacitor Cs, thus bringing the sampling transistor Tr1 out of conduction and electrically disconnecting the gate G of the drive transistor Trd from the signal line SL. As a result, the gate G of the drive transistor Trd varies in potential with the variation in potential of the source S of the same drive transistor Trd, which makes it possible to maintain constant the voltage Vgs between the gate G and the source S of the same drive transistor Trd.

### [Timing Chart 1]

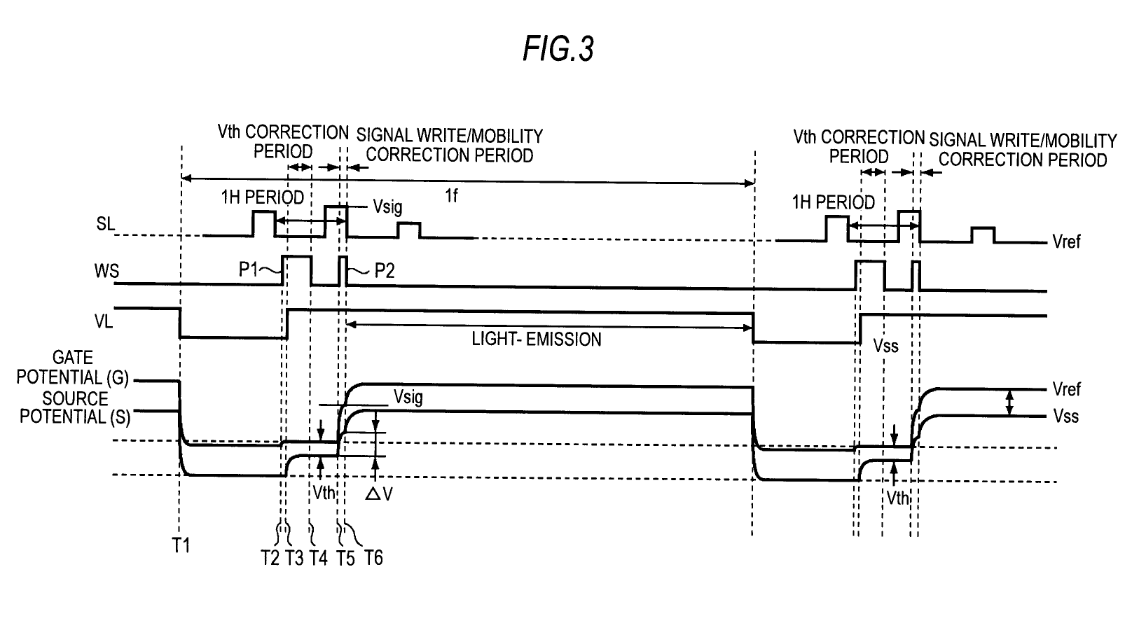

FIG. 3 is a timing chart illustrating the operation of the pixel circuit 2 shown in FIG. 2. This timing chart shows changes in potential of the scanning line WS, the power feed line VL, and the signal line SL on a common time axis. The timing chart also shows changes in potential of the gate G and source S of the drive transistor in parallel with the above changes in potential.

A control signal pulse is applied to the scanning line WS so as to turn on the sampling transistor Tr1. The control signal pulse is applied to the scanning line WS every frame (1f) in matching with line-sequential scanning of the pixel array section. The control signal pulse includes two pulses every horizontal scanning period (1H). The initial pulse is called a first pulse P1, and the subsequent pulse is called a second pulse P2. Similarly, the power feed line VL changes between the high potential Vdd and the low potential Vss every frame (1f). A video signal is supplied to the signal line SL. The video signal changes between the signal potential Vsig and the reference potential Vref every horizontal scanning period (1H).

As shown in the timing chart of FIG. 3, the pixel enters a non-light-emission period of the current frame from the light-emission period of the previous frame. Then, the pixel enters the light-emission period of the current frame. During the non-light-emission period, a preparatory operation, a threshold voltage correction operation, a signal write operation, and a mobility correction operation, and the like are performed.

During the light-emission period of the previous frame, the power feed line VL is at the high potential Vdd, causing the drive transistor Trd to supply the drive current Ids to the light-emitting element EL. The drive current Ids flows from the power feed line VL at the high potential Vdd through the light-emitting element EL via the drive transistor Trd into the cathode line.

Next, during the non-light-emission period of the current frame, the power feed line VL changes from the high potential Vdd to the low potential Vss at the time T1. When this happens, the power feed line VL is discharged down to Vss, and the potential of the source S of the drive transistor Trd falls to Vss. As a result, the anode potential of the light-emitting element EL (that is, the source potential of the drive transistor Trd) is reverse-biased. This shuts off the drive current, causing the light-emitting element to stop emitting light. Further, the potential of the gate G of the drive transistor drops with the drop in the potential of the source S of the same drive transistor.

Next, at the time T2, the scanning line WS changes from the low level to the high level, bringing the sampling transistor Tr1 into conduction. At this time, the signal line SL is at the reference potential Vref. Therefore, the gate G of the drive transistor Trd drops in potential to the reference potential Vref of the signal line SL via the conducting sampling transistor Tr1. At this time, the potential of the source S of the drive transistor Trd is at the potential Vss which is sufficiently lower than Vref. Thus, the voltage Vgs between the gate G and source S of the drive transistor Trd is initialized so as to be higher than the threshold voltage Vth of the drive transistor Trd. The period T1-T3 from the time T1 to the time T3 is a preparatory period in which the voltage Vgs between the gate G and source S of the drive transistor Trd is set higher than Vth.

Thereafter, at the time T3, the power feed line VL changes from the low potential Vss to the high potential Vdd, causing the source S of the drive transistor Trd to start rising in potential. When the voltage Vgs between the gate G and source S of the drive transistor Trd reaches the threshold voltage Vth after a while, the current stops flowing. Thus, the voltage corresponding to the threshold voltage Vth of the drive transistor Trd is written to the pixel capacitor Cs. This is the threshold voltage correction operation. At this time, the cathode potential Vcath is set such that the light-emitting element EL goes into cutoff to ensure that the majority of current flows through the pixel capacitor Cs and little current flows through the light-emitting element EL.

At the time T4, the scanning line WS changes from the high level and the low level. In other words, the first pulse P1 is removed from the scanning line WS, turning off the sampling transistor. As will be apparent from the above description, the first pulse P1 is applied to the gate of the sampling transistor Tr1 for the threshold voltage correction operation.

Thereafter, the signal line SL rises in potential from the reference potential Vref to the signal potential Vsig. Next, at the time T5, the scanning line WS changes from the low level to the high level again. In other words, the second pulse P2 is applied to the gate of the sampling transistor Tr1. Therefore, the sampling transistor Tr1 is turned on again to sample the signal potential Vsig from the signal line SL. As a result, the potential of the gate G of the drive transistor Trd is at the signal potential Vsig. Here, the light-emitting element EL is in cutoff (high impedance state) at first. Therefore, the majority of current flowing between the drain and source of the drive transistor Trd flows into the pixel capacitor Cs and the equivalent capacitor of the light-emitting element EL, thus starting to charge the capacitors. Thereafter, the source S of the drive transistor Trd rises in potential by ΔV until the time T6 when the sampling transistor Tr1 is turned off. Thus, the signal potential Vsig of the video signal is written to the pixel capacitor Cs so as to be added to Vth, and also the voltage ΔV for mobility correction is subtracted from the voltage held in the pixel capacitor Cs. As a result, the period T5-T6 from the time T5 to the time T6 is the signal write and mobility correction period. In other words, if the second pulse P2 is applied to the scanning line WS, the signal write and mobility correction operation is carried out. The signal write and mobility correction period T5-T6 is identical to the pulse width of the second pulse P2. That is, the pulse width of the second pulse P2 defines the mobility correction period.

Thus, during the signal write period T5-T6, the signal potential Vsig is written, and the correction amount ΔV is adjusted at the same time. The higher Vsig becomes, the larger current Ids is supplied from the drive transistor Trd, and therefore the larger the absolute value of ΔV becomes. As a result, mobility is corrected in accordance with the light-emission luminance level. If Vsig is maintained constant, the larger the mobility μ of the drive transistor Trd becomes, the larger the absolute value of ΔV becomes. In other words, the larger the mobility μ becomes, the larger the negative feedback amount ΔV to the pixel capacitor Cs becomes. This eliminates the variation in the mobility μ between the pixels.

Finally, at the time T6, as described above, the scanning line WS changes to the low level, turning off the sampling transistor Tr1. This disconnects the gate G of the drive transistor Trd from the signal line SL. At this time, the drain current Ids starts to flow through the light-emitting element EL. This causes the anode potential of the light-emitting element EL to rise in accordance with the drive current Ids. The rise of the anode potential of the light-emitting element EL is none other than the rise in the potential of the source S of the drive transistor Trd. If the source S of the drive transistor Trd rises in potential, the gate G of the drive transistor Trd will also rise in potential due to the bootstrap operation of the pixel capacitor Cs. The gate potential rises as mush as the source potential does. As a result, the input voltage Vgs between the gate G and source S of the drive transistor Trd is maintained constant during the light-emission period. The level of the gate voltage Vgs is equal to the level obtained by correcting the signal potential Vsig with the threshold voltage Vth and the mobility μ. The drive transistor Trd operates in the saturation region. That is, the drive transistor Trd outputs the drive current Ids according to the input voltage Vgs between the gate G and source S of the drive transistor Trd. The level of the gate voltage Vgs is equal to the level obtained by correcting the signal potential Vsig with the threshold voltage Vth and the mobility μ.

### [Timing Chart 2]

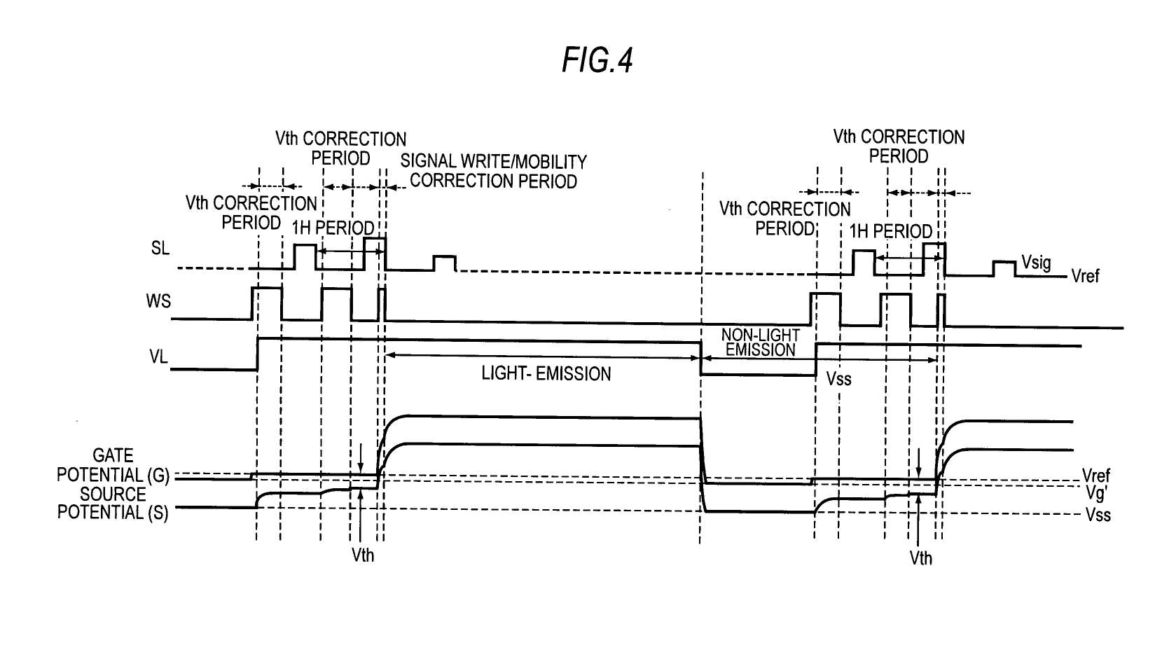

FIG. 4 is another timing chart illustrating the operation of the pixel circuit 2 shown in FIG. 2. This timing chart is basically identical to the timing chart shown in FIG. 2, and corresponding portions are represented by corresponding reference numerals. A difference is that the threshold voltage correction operation is repeatedly carried out over a plurality of horizontal periods in a time division manner. In the example of the timing chart of FIG. 4, the Vth correction operation is carried out two times every 1H period. If the screen section is high-definition, the number of pixels increases, thus causing an increase in the number of scanning lines. The increase in the number of scanning lines shortens the 1H period. Thus, if high-speed line-sequential scanning is carried out, the Vth correction operation may not be completed during the 1H period. Therefore, in the timing chart of FIG. 4, the threshold voltage correction operation is carried two times in a time division manner, such that the potential Vgs between the gate G and source S of the drive transistor Trd can be reliably initialized to Vth. The number of repetitions of Vth correction is not limited to two, and the number of time divisions may be increased if needed.

### [Reference Example of Light-Receiving Circuit]

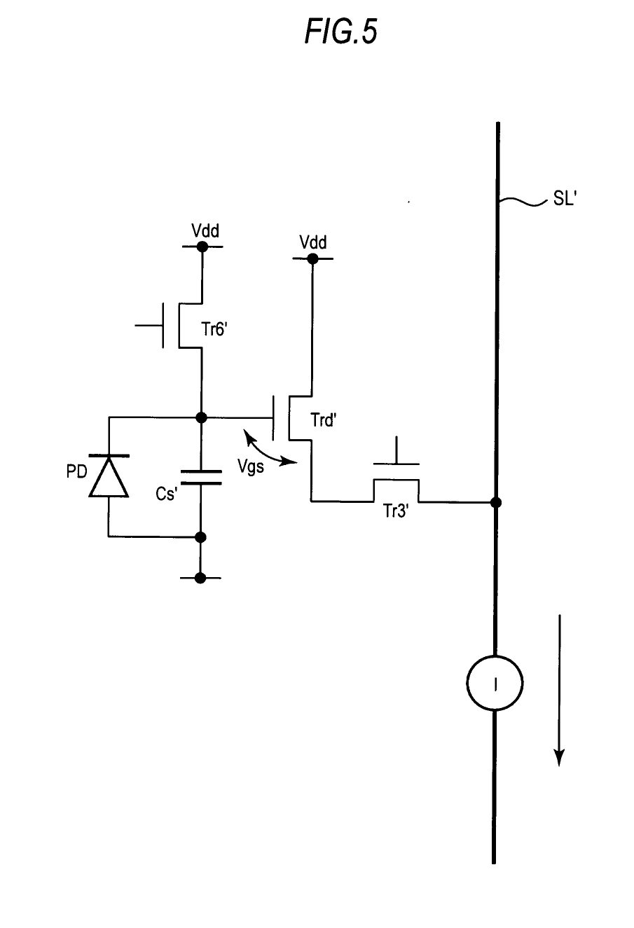

FIG. 5 is a schematic circuit diagram showing a reference example of a light-receiving circuit. As shown in FIG. 5, the light-receiving circuit includes one light-receiving element PD, three transistors Trd′, Tr3′, and Tr6′, and one holding capacitor Cs′. The light-receiving element PD is a two-terminal element, such as a photodiode or the like, and has a cathode connected to the gate of the drive transistor Trd′. The anode of the light-receiving element PD is grounded. The holding capacitor Cs′ is connected in parallel with the light-receiving element PD. The reset transistor Tr6′ is provided between the cathode of the light-receiving element PD and the power source Vdd. The drive transistor Trd′ is an N-channel transistor, and has a drain connected to the power source Vdd. The source of the transistor Tr6′ is connected to the signal line SL′ via the read transistor Tr3′.

Next, the operation of the light-receiving circuit will be described briefly with reference to FIG. 5. The reset transistor Tr6′ is first turned on, resetting the cathode of the light-receiving element PD to Vdd. Thereafter, the reset transistor Tr6′ is turned off. Thus, the light-receiving element PD is in the reverse bias state where the cathode becomes higher in potential than the anode.

Next, light is incident from the light source (not shown), and the light-receiving element PD starts the light-receiving operation. In the light-receiving element PD, an optical leak current flows from the cathode toward the anode in accordance with the amount of light received, and the holding capacitor Cs′ is discharged. When this happens, the gate potential of the drive transistor Trd′ falls. The larger the amount of light received becomes and the larger optical leak current flows, the more significantly the gate potential of the drive transistor Trd′ falls.

Thereafter, the read transistor Tr3′ is turned on, causing the current to flow from the drive transistor Trd′ toward the signal line SL′. This current is measured by an ammeter I connected to the signal line SL′. The amount of current measured varies depending on the amount of light received by the light-receiving element PD. In this example, the larger the amount of light received becomes, the smaller the amount of current becomes. The amount of light received is in proportion to the luminance of the light source. Therefore, the amount of current measured is a luminance signal which indicates the light-emission luminance of the light source. Thus, the light-receiving circuit drives the light-receiving element by the drive transistor Trd′, thus receiving the luminance signal of the light source (light-emitting element) on the signal line SL′. In other words, the drive transistor Trd′ operates a source follower of the light-receiving circuit.

### First Embodiment

### [Overall Configuration of Panel]

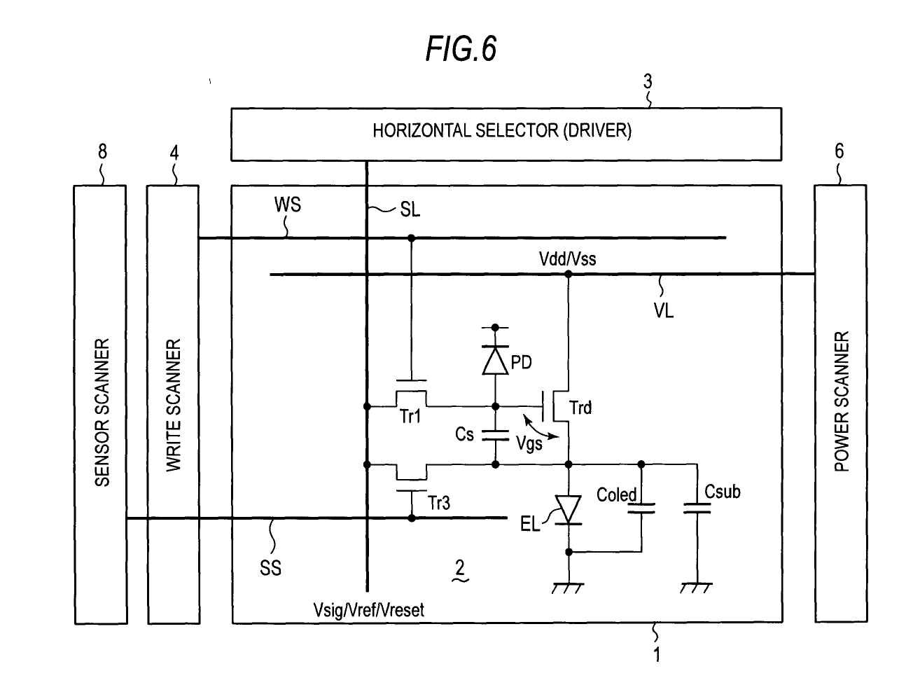

FIG. 6 is a diagram showing the overall configuration of a panel which is a main portion of a display device according to a first embodiment of the invention. The display device is configured such that the light-receiving circuit according to the reference example shown in FIG. 5 is incorporated into the pixel circuit according to the reference example shown in FIG. 2. However, the light-receiving circuit shown in FIG. 5 has a large number of elements, and it is difficult to layout the light-receiving circuit on each pixel shown in FIG. 2 as it is in terms of yield and the like. Therefore, in the first embodiment of the invention, the elements can be used in common with the light-emitting circuit and the light-receiving circuit as many as possible. As a result, the light-receiving element can be incorporated into the pixel circuit while the number of elements of the pixel circuit can be minimized.

The display device according to first embodiment basically includes a screen section, a drive section, and a signal processing section. FIG. 6 shows a panel having a screen section and a drive section of the display device. As shown in FIG. 6, a screen section 1 includes scanning lines WS arranged in rows, signal lines SL arranged in columns, and pixels 2 disposed at intersections of the scanning lines WS and the signal lines SL and arranged in a matrix. In this embodiment, power feed lines VL are also formed in parallel with the scanning lines WS. Additional scanning lines SS are also formed in parallel with the scanning lines. WS.

The drive section is disposed in the peripheral portion of the panel so as to surround the screen section 1. The drive section includes a horizontal selector (driver) 3, a write scanner 4, a power scanner 6, and a sensor scanner 8. The write scanner 4 sequentially supplies a control signal to the scanning lines WS. The driver 3 supplies a video signal to the signal lines SL. The video signal includes a predetermined reset potential Vreset, in addition to the signal potential Vsig and the reference potential Vref. The power scanner 6 supplies a power supply voltage, which changes between the high potential Vdd and the low potential Vss, to the power feed lines VL. The sensor scanner 8 sequentially supplies an additional control signal to the additional scanning lines SS in synchronization with the write scanner 4.

Each pixel 2 receives the signal potential Vsig of the video signal from the signal line SL when being selected in response to the control signal supplied from the scanning line WS, and includes at least a light-emitting element EL, a light-receiving element PD, and a drive transistor Trd. The light-emitting element EL is, for example, an organic EL device. The light-receiving element PD is, for example, a PIN diode. However, the invention is not limited to the above, but various light-emitting devices and light-receiving devices may be used.

The drive transistor Trd outputs the drive current according to the video signal Vsig received on the pixel 2 to the light-emitting element EL so as to cause the light-emitting element EL to emit light, and extracts a luminance signal output from the light-receiving element PD which detects light-emission luminance. Thus, the pixel according to this embodiment is configured such that the light-emitting element EL and the light-receiving element PD are driven by one drive transistor Trd, so the number of elements can be reduced accordingly. The signal processing section (not shown) provided separately from the panel corrects the video signal in accordance with the extracted luminance signal and supplies the corrected video signal to the driver 3 of the drive section.

The pixel circuit 2 includes a sampling transistor Tr1, a read transistor Tr3 and a pixel capacitor Cs, in addition to the light-emitting element EL, the light-receiving element PD, and the drive transistor Trd which are basic elements. The sampling transistor Tr1 has a gate connected to the scanning line WS. The sampling transistor Tr1 also has a pair of current terminals (source/drain) connected between the signal line SL and the gate of the drive transistor Trd. The read transistor Tr3 has a gate connected to the additional scanning line SS. The read transistor Tr3 also has a pair of current terminals (source/drain) connected between the signal line SL and the source of the drive transistor Trd. The pixel capacitor Cs is connected between the gate and source of the drive transistor Trd. Further, an auxiliary capacitor Csub is connected between the source of the drive transistor Trd and the ground. The equivalent capacitor of the light-emitting element EL is represented by Coled.

The video signal which is received via the sampling transistor Tr1 is applied to the gate of the drive transistor Trd. The light-emitting element EL emits light in accordance with the drive current which is output from the source of the drive transistor Trd in accordance with the signal potential Vsig of the video signal applied to the gate of the drive transistor Trd. The light-receiving element PD is connected to the gate of the drive transistor Trd, and the drive transistor Trd operates as a source follower. The luminance signal is output from the source of the drive transistor Trd.

The drive transistor Trd of the pixel 2 operates in a time division manner during a light-emission period and a light-reception period. During the light-emission period, the drive transistor Trd outputs the drive current of the light-emitting element EL of the relevant pixel 2 so as to cause the light-emitting element EL to emit light. Meanwhile, during the light-reception period, the light-receiving element PD of the relevant pixel 2 detects the light-emission luminance of a light-emitting element of a pixel different from the relevant pixel and outputs the luminance signal. In this case, the drive transistor Trd extracts the luminance signal output from the light-receiving element PD of the relevant pixel 2. During the light-reception period, it is desirable that the light-receiving element PD of the relevant pixel 2 detect the light-emission luminance of a light-emitting element of a pixel adjacent to the relevant pixel 2 and output the luminance signal.

In this embodiment, the drive transistor Trd supplies the luminance signal extracted from the light-receiving element PD to the signal line SL via the read transistor Tr3. The signal processing section (not shown) provided outside the panel receives the luminance signal from the signal line SL, corrects the video signal, and supplies the corrected video signal to the driver 3 of the drive section. The signal processing section compares a first luminance signal output from the light-receiving element PD at the beginning and a second luminance signal output from the light-receiving element PD after a predetermined time has passed from the beginning so as to calculate the amount of decrease of the light-emission luminance. Further, in order to compensate for the amount of decrease of the light-emission luminance, the video signal is corrected and output to the driver 3 of the drive section.

As will be apparent from the above description, in the first embodiment, the drive transistor Trd of the pixel 2 is used as the source follower of the light-receiving element PD. The pixel capacitor Cs is used in common with the light-emitting element EL and the light-receiving element PD. Further, as the wire for outputting the luminance signal obtained from the light-receiving element PD, the signal line SL is used. As a result, the only elements newly added are the light-receiving element PD (photodiode) and the read transistor Tr3, as compared to the pixel circuit according to the reference example shown in FIG. 2. Meanwhile, the drive section is further provided with the sensor scanner 8 for line-sequential scanning of the read transistor Tr3, in addition to the write scanner 4 and the power scanner 6. The screen section 1 and the drive section may be integrated into, for example, a thin film transistor (TFT) substrate. The thin film transistors of the pixel 2 may be formed by TFTs. As the TFT, a polysilicon thin film transistor (LTPSTFT) may be used which can be formed at a comparatively low temperature, for example, at 600° C. or less.

### [Operation]

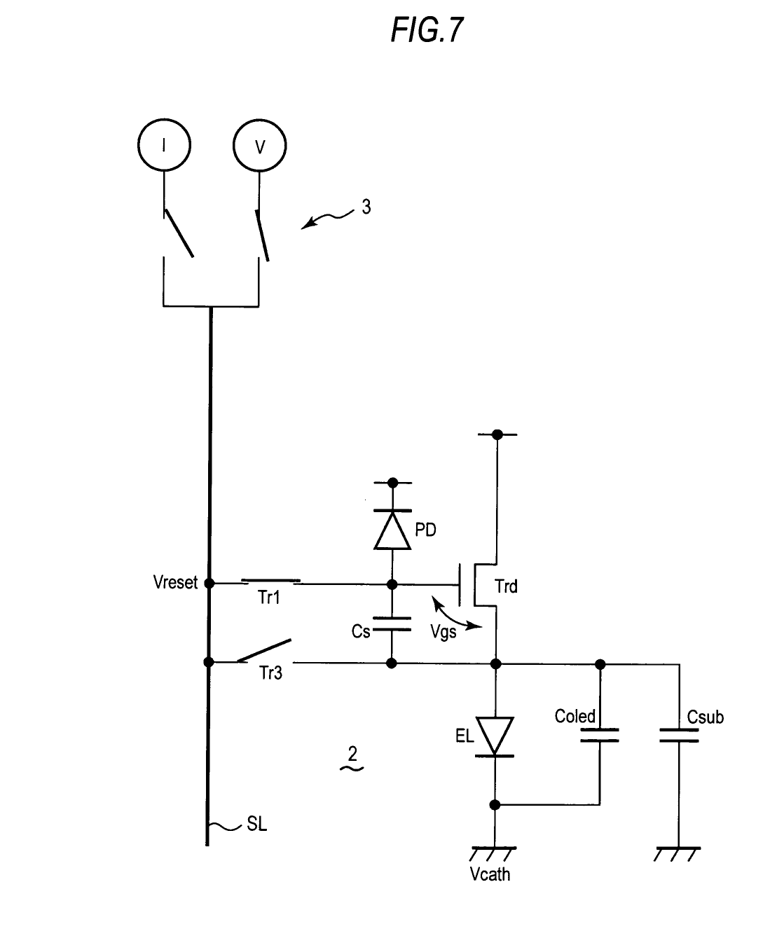

Next, the operation of the display device shown in FIG. 6 will be described with reference to FIGS. 7 to 9. The light-emitting operation is identical to that of the display device according to the reference example shown in FIG. 2. However, when the normal pixel operation is carried out during the light-emission period, the read transistor Tr3 is constantly turned off. Further, a positive voltage is applied to the cathode of the photodiode PD, so the photodiode PD is in the reverse bias state such that sensitivity is minimized. Here, the light-receiving operation will be described in detail with reference to FIGS. 7 to 9.

### [Reset Operation]

During the light-reception period, first, a reset operation shown in FIG. 7 is carried out. The cathode potential Vcath initially rises, causing the light-emitting element EL to go into cutoff. In this state, the sampling transistor Tr1 is turned on so as to write the reset potential Vreset to the gate of the drive transistor Trd from the signal line SL. The driver 3 is connected to the signal line SL. The driver 3 includes a signal source V and an ammeter I. During the reset operation, the reset potential Vreset is supplied from the signal source V to the signal line SL. With this reset operation, the light-receiving circuit of the pixel 2 is initialized.

### [Background Measurement]

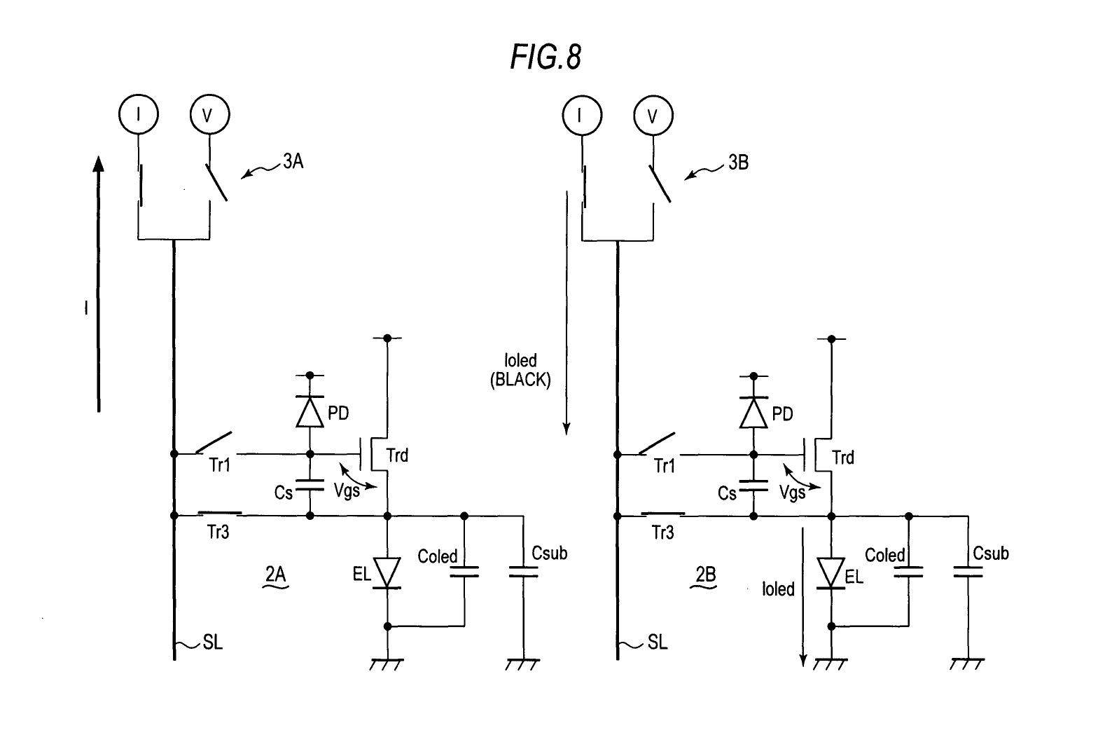

Next, background measurement shown in FIG. 8 is carried out. FIG. 8 shows a pair of adjacent pixels. One pixel is a relevant pixel 2A in which the light-receiving operation is carried out, and the other pixel is an adjacent pixel 2B adjacent to the relevant pixel 2A. For the background measurement, the sampling transistor Tr1 of the relevant pixel is turned off and the read transistor Tr3 is turned on. At this time, the signal line SL of the relevant pixel 2A is connected to the ammeter I. A constant current Ioled is supplied from the driver 3B to the light-emitting element EL of the adjacent pixel 2B. The constant current Ioled is so weak that the light-emitting element EL will not emit light.

In this state, the light-receiving element PD of the relevant pixel 2A will not receive light other than noise. In a state where no light is incident on the light-receiving element PD of the relevant pixel 2A, the gate potential of the drive transistor Trd (that is, the reset potential Vreset) is extracted by source-follower driving, and is output to the signal line SL via the read transistor Tr3 which is turned on. The current output to the signal line SL is measured by the ammeter I and stored as a luminance signal in a memory.

### [Luminance Measurement]

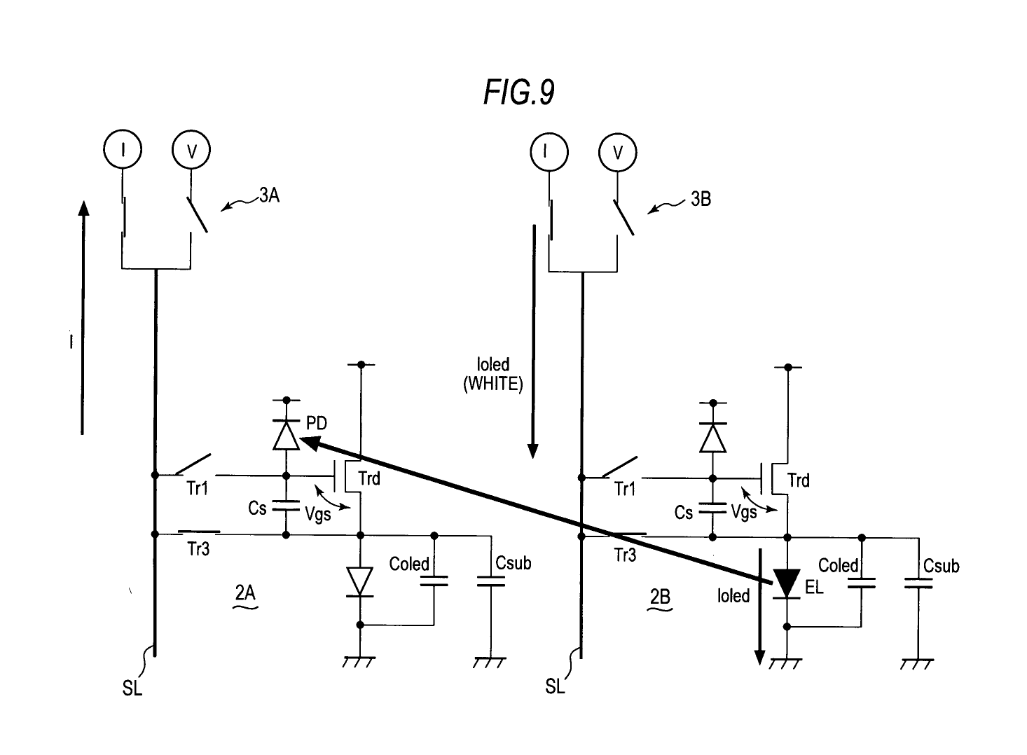

FIG. 9 shows a luminance measurement operation. For the luminance measurement, the light-emitting element EL of the adjacent pixel 2B emits light and the luminance of light emitted is detected by the light-receiving element PD of the relevant pixel 2A. As described above, it is assumed that the light-emitting element EL which emits light is provided in the adjacent pixel 2B to the relevant pixel 2A which carries out luminance measurement.

In order to cause the light-emitting element EL of the adjacent pixel 2B to emit light, the read transistor Tr3 is turned on. Then, the constant current Ioled flows from a constant current source I of the driver 3B to the signal line SL corresponding to the adjacent pixel 2B. In this case, it is assumed that the current level is the white level at which the light-emitting element EL emits light with high luminance. The constant current supplied to the signal line SL flows through the light-emitting element EL via the read transistor Tri. The light-emitting element EL of the adjacent pixel 2B emits light in accordance with the constant current.

Light emitted from the adjacent pixel 2B is received by the light-receiving element PD of the relevant pixel 2A. The photodiode constituting the light-receiving element PD is reverse-biased by the above-described reset operation. Therefore, if light is irradiated onto the light-receiving element PD, the optical leak current flows. For this reason, the gate potential of the drive transistor Trd of the relevant pixel 2A rises by the optical leak current, and the corresponding voltage is output as a luminance signal to the signal line SL by the source follower operation of the drive transistor Trd. The luminance signal is also stored in a memory provided inside or outside the panel. The light-receiving operation is carried out for a predetermined period, the output voltage (luminance signal) is compared with the luminance signal at the time of background measurement, and the net light-emission luminance is calculated from the difference. Thus, the light-emission luminance can be measured in terms of pixels.

### [Signal Correction Operation]

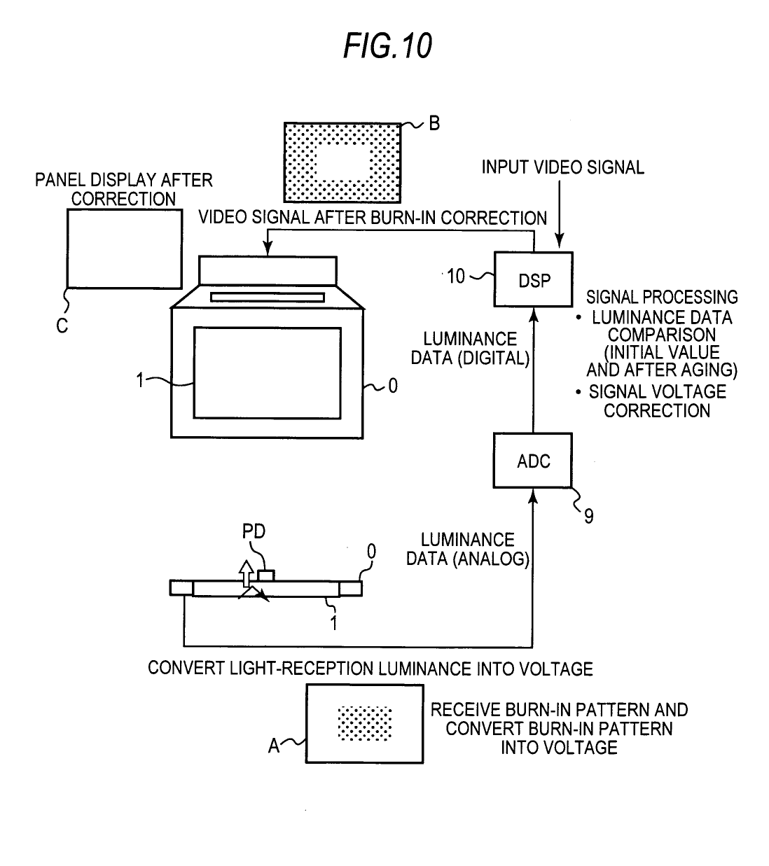

FIG. 10 is a schematic block diagram showing the overall configuration of the display device according to the first embodiment of the invention. As shown in FIG. 10, the display device basically includes a screen section 1, a drive section, and a signal processing section 10. The screen section (pixel array section) 1 and the drive section are configured as shown in FIG. 6 and laminated as a panel 0 on the same substrate.

As described with reference to FIG. 7, each of the pixels provided in the screen section 1 includes the light-emitting element EL and the light-receiving element PD. The light-emitting element EL receives the video signal from the corresponding signal line when being selected in response to the control signal supplied from the corresponding scanning line, and emits light in response to the received video signal. Meanwhile, the light-receiving element PD detects the light-emission luminance of a light-emitting element of an adjacent pixel and outputs a corresponding luminance signal A to the signal line.

The signal processing section (DSP) 10 corrects the video signal in accordance with the luminance signal output from each light-receiving element PD, and supplies the corrected video signal to the driver of the drive section. In this embodiment, AD converter (ADC) 9 is provided between each light-receiving element PD and the signal processing section 10. The ADC 9 converts the analog luminance signal A output from the light-receiving element PD into a digital luminance signal (luminance data) and supplies the digital luminance signal to the digital signal processing section (DSP) 10.

According to this embodiment, the signal processing section 10 corrects the video signal in accordance with the luminance signal A output from the light-receiving element PD and supplies the corrected video signal B to the driver of the drive section. Thus, the panel 0 can display an image C with luminance irregularity having been corrected. With this configuration, the degradation in luminance of the pixel can be compensated by correcting the video signal, and image quality defects, such as “burn-in” and the like, which are inherent in the related art can be suppressed. In particular, according to this embodiment, the light-receiving element PD detects the light-emission luminance of each pixel and outputs the corresponding luminance signal. The light-emission luminance is detected for each pixel, so even if local luminance irregularity appears on the screen, local luminance irregularity can be corrected by correcting the video signal in terms of pixels.

As will be apparent from the above description, in this embodiment, the light-receiving element PD is provided for each pixel of the panel 0. With this light-receiving element PD, the degradation in luminance of the pixel is measured, and the level of the video signal is adjusted in matching with the degree of degradation. Thus, an image with “burn-in” having been corrected can be displayed on the screen section 1. FIG. 10 schematically shows a display pattern A in which burn-in is produced, a video signal pattern B after burn-in correction, and a display pattern C after burn-in correction. The irregularity in the pattern A and the pattern B is cancelled, and the pattern C with no irregularity is obtained.

### [Burn-in Phenomenon]

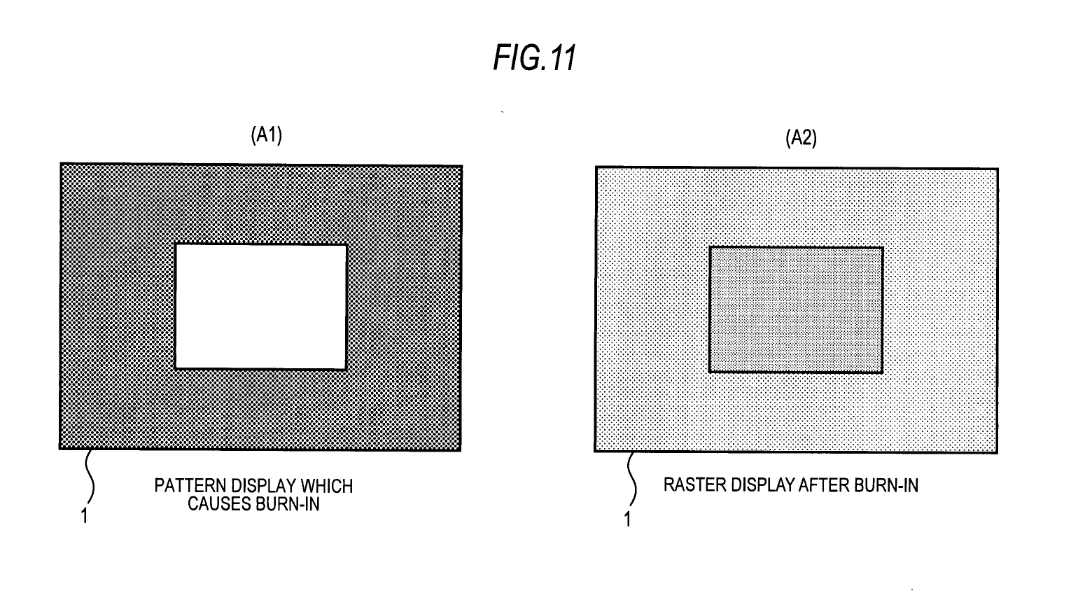

FIG. 11 is a schematic view illustrating “burn-in” that will be processed. (A1) shows a pattern display which causes burn-in. For example, a window as shown in the drawing is displayed on the screen section 1. The pixels in the blank window continue to emit light with high luminance, and the pixels in the black frame portion around the blank window are in the non-light-emission state. If the window pattern is displayed for a long time, while the pixels in the blank portion undergo degradation in luminance, the pixels in the black frame portion are relatively slowly degraded in luminance.

(A2) shows a state where the window pattern display shown in (A1) is erased, and raster display is performed uniformly over the entire surface of the screen section 1. When raster display is performed on the screen section 1, uniform luminance distribution is supposed to be obtained over the entire surface if local degradation in luminance is not produced. However, actually, the pixels in the central portion where blank display was performed undergo degradation in luminance, so the luminance of the central portion becomes lower than the luminance of the peripheral portion, that is, so-called “burn-in” is produced.

### [Light-Emission Luminance Detection Operation]

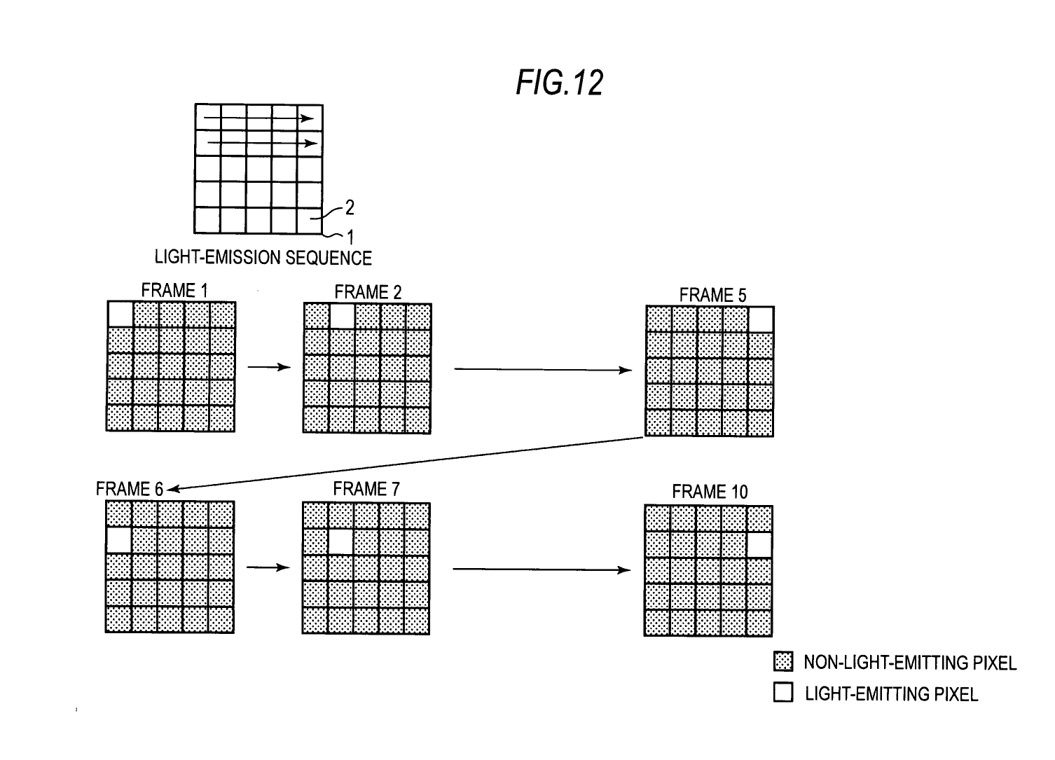

FIG. 12 is a schematic view showing the detection operation of the luminance of each pixel. As shown in FIG. 12, in this embodiment, the light-emission luminance of each pixel is detected by the dot-sequential method. The dot-sequential operation is carried out by the raster method from the upper left pixel to the lower right pixel on the screen section 1. For simplification, the screen section 1 includes 25 pixels 2 of 5 rows and 5 columns. The actual display device includes, for example, several million pixels.

During a first frame 1, the pixel 2 at the upper left corner of the screen section 1 emits light, and the remaining pixels 2 belonging to the screen section 1 are in the non-light-emission state. Thus, the light-receiving element can detect the light-emission luminance of the pixel 2 at the upper left corner of the screen section 1.

Next, during a frame 2, only the second pixel 2 from the upper left corner emits light, and the luminance thereof is detected. Hereinafter, detection is carried out in sequence, and during a frame 5, the light-emission of the pixel 2 at the upper right corner can be detected. Next, during a frame 6, the light-emission luminance of the pixel in the second row is detected, and detection is carried out in sequence from a frame 7 to a frame 10. During the frame 10, the light-emission luminance of the pixels 2 at the right end in the second row from above can be detected. Thus, the light-emission luminance of the 25 pixels 2 constituting the screen section 1 can be detected from the frame 1 to the frame 25. For example, if the frame frequency is 30 Hz, the light-emission luminance of all of the pixels 2 can be detected within about 1 second.

As will be apparent from the above description, in this embodiment, the pixels dot-sequentially emit light one by one. In the case of a color display device, the light-emitting element provided in each pixel emits light of one of the three colors of RGB. In this case, it is desirable to detect the light-emission luminance for each pixel of each color (subpixel). As occasion demands, the light-emission luminance may be detected for each pixel having subpixels of the three colors of RGB.

### [Burn-in Correction Processing]

FIG. 13 is a schematic view showing the “burn-in” correction operation shown in FIG. 11. (O) shows the video signal which is output from the outside to the signal processing section of the display device. In the example shown in the drawing, the overall solid video signal is displayed.

(A) shows the luminance distribution when the video signal shown in (O) is displayed on the screen section where “burn-in” shown in FIG. 11 is produced. Even if the video signal is input, local burn-in is produced in the screen section of the panel, so the luminance of the central window portion is darkened compared to the peripheral frame portion.

(B) shows the video signal when the video signal (O) input from the outside is corrected in accordance with the detection result of the light-emission luminance of each pixel. The video signal after burn-in correction shown in (B) is corrected such that the video signal which is written to the pixel in the central window portion is at a relatively high level, and the video signal which is written to the pixel in the peripheral frame portion is at a relatively low level. Thus, in order to cancel the negative luminance distribution due to burn-in shown in (A), the correction is carried out such that the video signal has the position luminance distribution shown in (B).

(C) schematically shows a state where the video signal after burn-in correction is displayed on the screen section. An unbalanced luminance distribution due to burn-in on the screen section of the panel is compensated by the video signal for burn-in correction, so a screen with a uniform luminance distribution is obtained.

First, the pixels are turned on one by one so as to acquire luminance data of each pixel before the panel shipment. As the signal voltage used, the same voltage is used for the respective pixels. However, when the subpixels are turned on one by one, the signal voltage may differ between the respective colors of RGB.

A pixel emits light, the light-receiving element detects the luminance of light emitted, and the obtained luminance signal is converted into voltage data. Thereafter, signal amplification and digital-to-analog conversion are carried out, and data is stored in the memory. A series of operations are performed for all of the pixels. Thereafter, after a predetermined time has passed after light-emission, such as at the time of the panel shipment or the like, the same operations as described above are carried out so as to acquire pixel luminance data after burn-in. At this time, with regard to the input signal voltage, a signal having the same value as the initial value is input. The pixel drive operation is also carried out in the same manner as that at the beginning. Thus, the deterioration in luminance efficiency of the light-emitting element can be accurately measured. Here, the same predetermined signal as that at the beginning is used, so correction after time has elapsed is carried out when the video signal will not be input to the panel. For example, correction may be carried out when the panel does not operate as a monitor. In the case of a notebook-type personal computer or a cellular phone, correction may be carried out when the cover is closed.

Pixel luminance data at the beginning and pixel luminance data after time has elapsed, which are obtained in the above manner, are compared with each other so as to calculate the amount of degradation of the current. The burn-in correction processing is performed on the input video signal on the basis of current degradation data for each pixel, and a corrected signal voltage is input to the panel. As a result, as shown in FIG. 13, an image with high uniformity in which no burn-in is produced can be obtained. Therefore, degradation in luminance can be detected for each pixel, and an image in which no burn-in is produced can be obtained by correcting signal data. This makes it possible to cope with burn-in which is inherent in the self-luminous panel. According to this embodiment, in the organic EL panel, a light-receiving element is provided in the panel system, each pixel emits light, and the luminance of the pixel is measured. This measurement is carried out before shipment and after a predetermined light-emission time has passed, and the amount of degradation in luminance of each pixel is calculated by comparing measurement data with each other. Burn-in correction is performed on input video data on the basis of the amount of degradation in luminance, and corrected video data is input to the panel. In this way, the degradation in luminance in the organic EL element can be corrected, and thus a high-quality panel with burn-in having been corrected can be obtained.

### Second Embodiment

### [Configuration of Panel of Display Device]

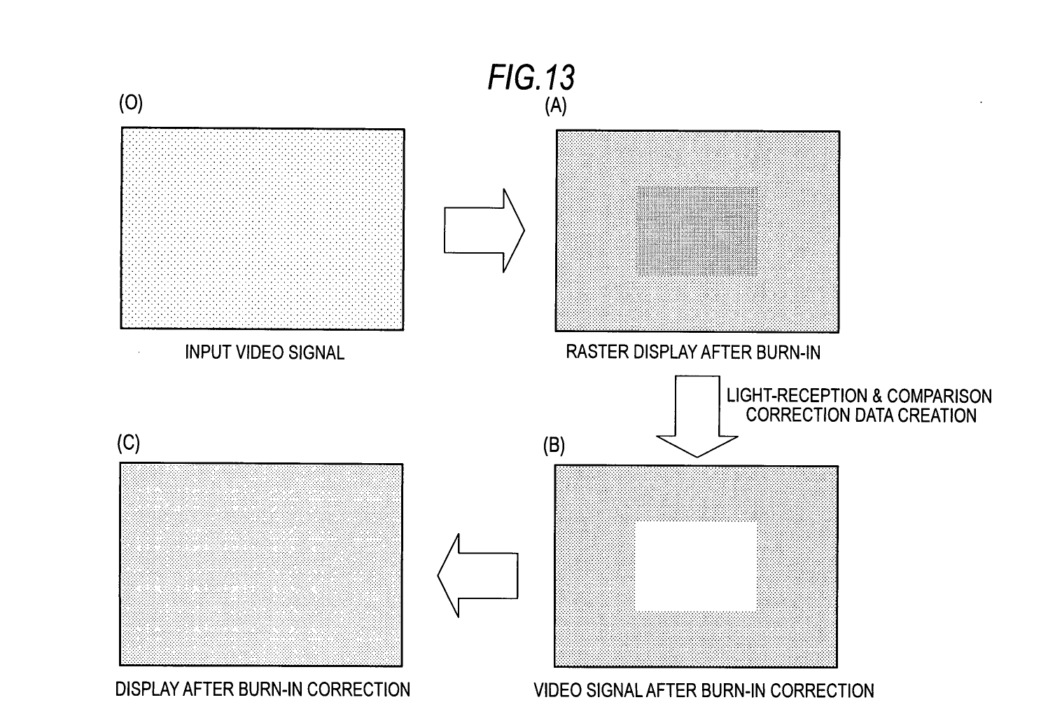

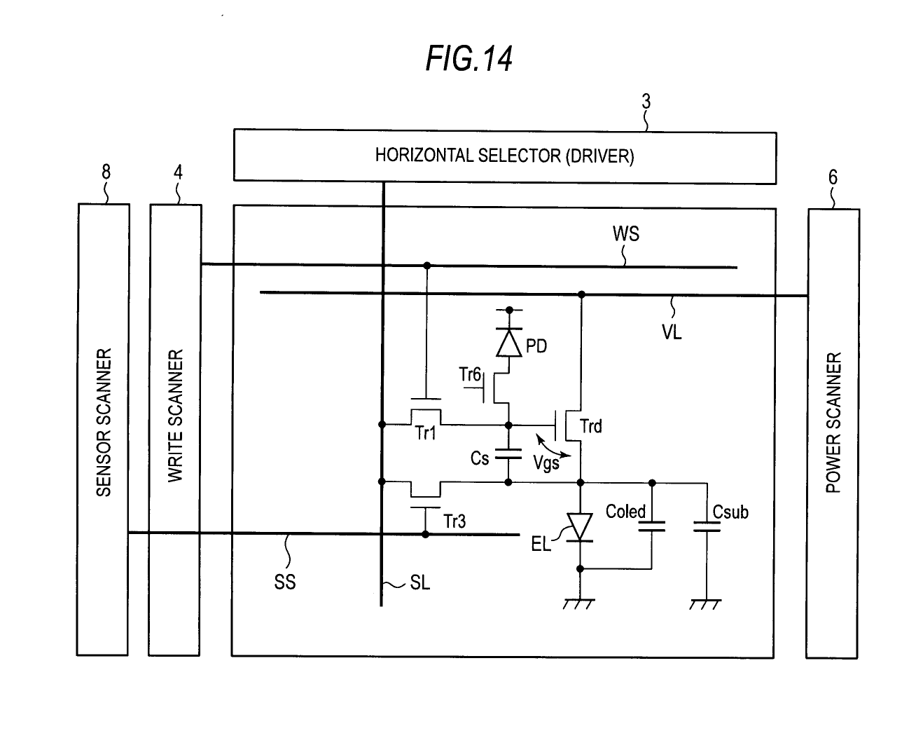

FIG. 14 is a schematic block diagram showing a display device according to a second embodiment of the invention. For ease of understanding, portions corresponding to the panel of the first embodiment shown in FIG. 6 are represented by corresponding reference numerals. A difference is that a shutter transistor Tr6 is provided between the anode of the light-receiving element PD and the gate of the drive transistor Trd. The shutter transistor Tr6 is turned on only during the light-reception period, such that the optical leak current output from the light-receiving element PD is applied to the gate of the drive transistor Trd. During a period (including the light-emission period and the correction period) other than the light-reception period, the shutter transistor Tr6 is turned off, such that the light-receiving element PD does not adversely affect the light-emission operation of the light-emitting element EL. In this embodiment, the light-receiving element PD is a PIN diode. However, the invention is not limited thereto, but a different type of light-receiving element may be incorporated. As occasion demands, the light-emitting element EL may be used as a light-receiving element. As the panel substrate on which the screen section and the drive section are laminated, a LTPSTFT substrate is typically used. However, the invention is not limited thereto, but an a-SiTFT substrate or a single-crystal MOS substrate may be used.

### Third Embodiment

### [Configuration of Panel]

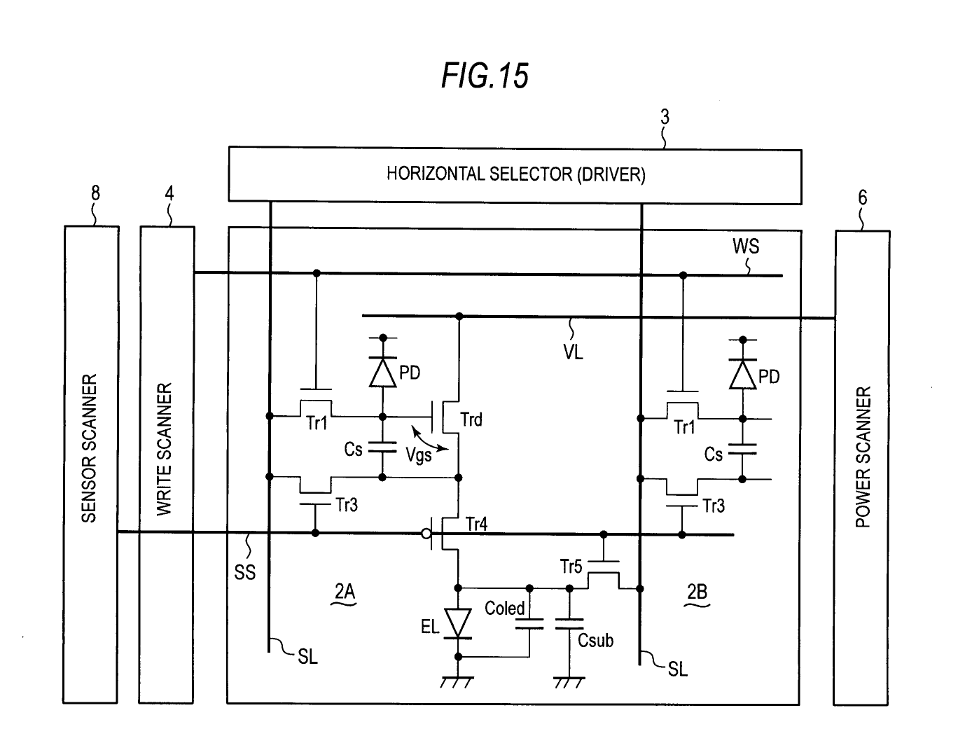

FIG. 15 is a circuit diagram showing a display device according to a third embodiment of the invention. For ease of understanding, portions corresponding to the panel of the first embodiment shown in FIG. 6 are represented by corresponding reference numerals. For explanation, FIG. 15 shows a portion of the adjacent pixel 2B, in addition to the relevant pixel 2A. A difference from the panel of the first embodiment shown in FIG. 6 is that two switching transistors Tr4 and Tr5 are added to the pixel 2A. One switching transistor Tr4 is a P-channel transistor, and has a pair of current terminals connected between the source of the drive transistor Trd and the anode of the light-emitting element EL. The switching transistor Tr4 has a gate connected to the scanning line SS. The other switching transistor Tr5 is an N-channel transistor, and has a pair of current terminals connected between the anode of the light-emitting element EL of the relevant pixel 2A and the signal line SL of the adjacent pixel 2B. The switching transistor Tr5 has a gate connected to the scanning line SS.

A pair of switching transistors Tr4 and Tr5 complementarily operate in response to the control signal applied to the scanning line SS. During the light-emission period of the relevant pixel 2A, the switching transistor Tr4 is turned on, but during the light-reception period, the switching transistor Tr5 is turned on. During the light-emission period, the light-emitting element EL of the relevant pixel 2A emits light with luminance according to the video signal by the drive transistor Trd. During the light-reception period, the switching transistor Tr5 is turned on, and the light-emitting element EL emits light with predetermined luminance in accordance with a constant current supplied from the signal line SL of the adjacent pixel 2B. Light emitted from the light-emitting element EL is received by the light-receiving element PD of the relevant pixel 2A.

### [Operation of Panel]

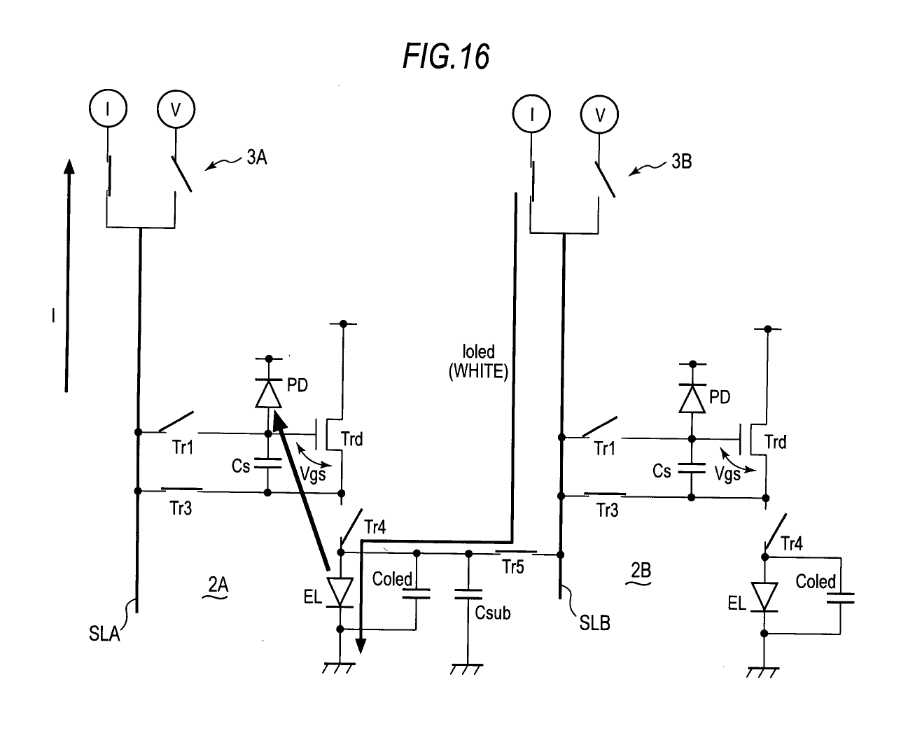

FIG. 16 is a schematic view illustrating the operation of the display device shown in FIG. 15. This schematic view shows the relevant pixel 2A and the adjacent pixel 2B. As described above, during the light-reception period, the light-emitting element EL of the relevant pixel 2A emits light with predetermined luminance with in accordance with the constant current Ioled supplied from the signal line SLB corresponding to the adjacent pixel 2B.

The light-receiving element PD of the relevant pixel 2A receives light emitted from the light-emitting element EL of the same pixel, thereby charging the resultant optical leak current in the pixel capacitor Cs and applying the optical leak current to the gate of the drive transistor Trd. The drive transistor Trd operates as a source follower, and outputs the current according to the amount of optical leak current accumulated in the pixel capacitor Cs to the signal line SLA of the relevant pixel 2A as the luminance signal.

As will be apparent from the above description, in this embodiment, the drive transistor Trd of the relevant pixel 2A operates in a time division manner during the light-emission period and the light-reception period. During the light-emission period, the drive transistor Trd outputs the drive current to the light-emitting element EL of the relevant pixel 2A so as to cause the light-emitting element EL to emit light. During the light-reception period, the light-receiving element PD of the relevant pixel 2A detects the luminance of light emitted from the light-emitting element

EL of the same relevant pixel 2A, and outputs the luminance signal (optical leak current). The drive transistor Trd extracts the luminance signal output from the light-receiving element PD of the relevant pixel 2A and outputs the luminance signal to the signal line SLA.

During the light-emission period, the light-emitting element EL of the relevant pixel 2A emits light in accordance with the drive current which is output from the drive transistor Trd in response to the video signal. During the light-reception period, the light-emitting element EL of the relevant pixel 2A emits light in accordance with the constant current Ioled (white) which is supplied through a separate route from the drive transistor Trd. At this time, the light-receiving element PD of the relevant pixel 2A detects the luminance of light emitted from the light-emitting element EL of the same relevant pixel 2A which emits light in accordance with the constant current Ioled (white), and outputs the luminance signal to the signal line SLA. In this embodiment, the signal line SLB corresponding to the adjacent pixel is used as the separate route through which the constant current is supplied to the light-emitting element EL of the relevant pixel 2A.

### Fourth Embodiment

### [Configuration of Panel]

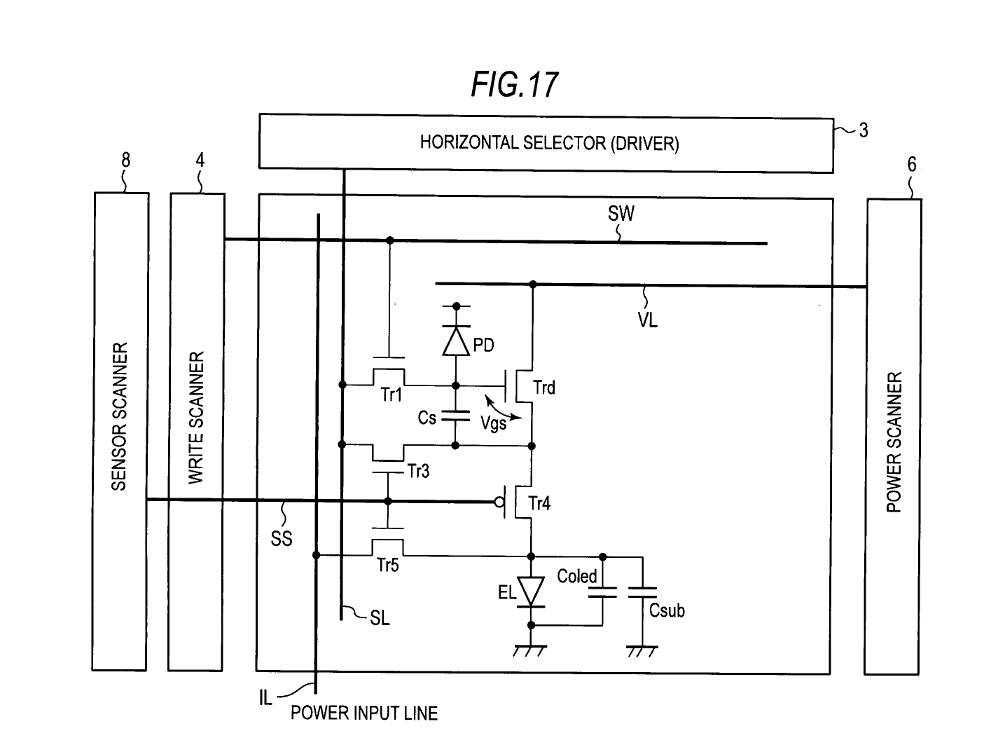

FIG. 17 is a schematic view showing a panel of a display device according to a fourth embodiment of the invention. For ease of understanding, portions corresponding to the panel of the third embodiment shown in FIG. 15 are represented by corresponding reference numerals. A difference is that the switching transistor Tr5 is connected to a current input line IL disposed to correspond to the relevant pixel, not to the signal line of the adjacent pixel. In this embodiment, the current input line IL serves as the above-described separate route through which the constant current Ioled (white) is supplied to the light-emitting element EL during the light-reception period.

### [Operation]

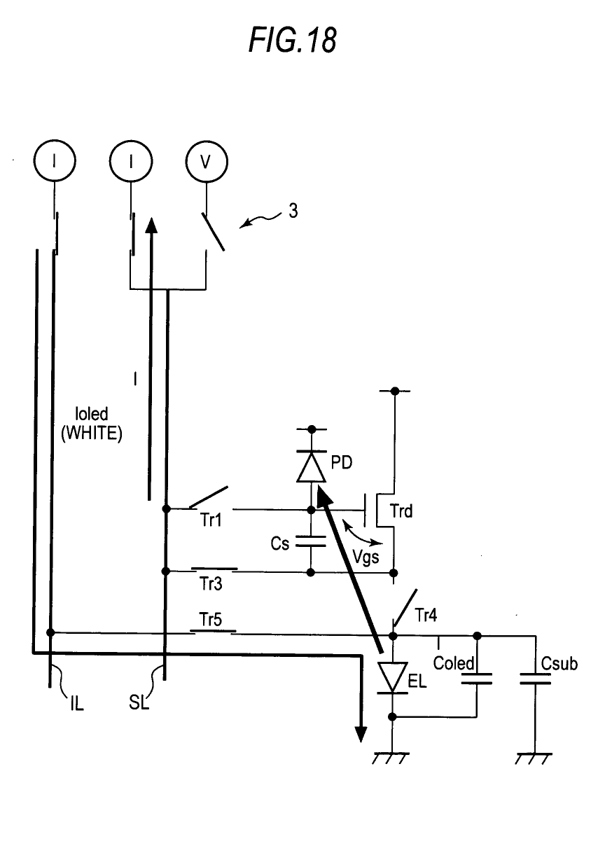

FIG. 18 is a schematic circuit diagram illustrating the light-receiving operation of the fourth embodiment shown in FIG. 17. As shown in FIG. 18, during the light-reception period, the switching transistor Tr4 is turned off, and the switching transistor Tr5 is turned on. The anode of the light-emitting element EL is connected to the current input line IL. The constant current Ioled (white) flows from the driver 3 through the light-emitting element EL via the current input line IL. Thus, the light-emitting element EL emits light with predetermined luminance.

The light-receiving element PD receives light emitted from the light-emitting element EL of the same pixel, and detects the luminance of light emitted. The drive transistor Trd operates as a source follower so as to extract a signal output from the light-receiving element PD and to output the extracted signal to the signal line SL.

### <Applications>

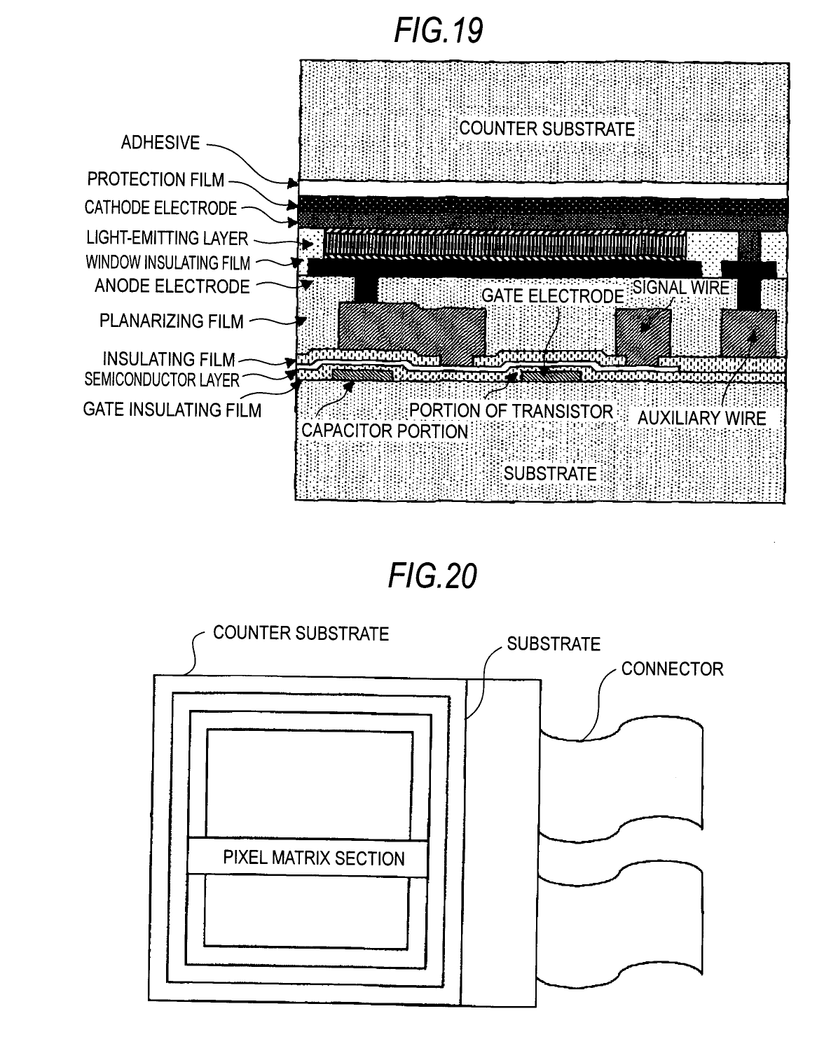

The display device according to each embodiment of the invention has a thin film device configuration shown in FIG. 19. FIG. 19 shows a case where a TFT portion has a bottom-gate structure (a gate electrode is provided below a channel PS layer). In addition, the TFT portion may have a sandwich-gate structure (a channel PS layer is interposed between upper and lower gate electrodes), or a top-gate structure (a gate electrode is disposed above a channel PS layer). FIG. 19 shows a schematic sectional structure of a pixel formed on an insulating substrate. As shown in FIG. 19, each pixel includes a transistor portion having a plurality of thin film transistors (in FIG. 19, one TFT is shown), a capacitor portion, such as a pixel capacitor and the like, and a light-emitting portion, such as an organic EL element or the like. The transistor portion and the capacitor portion are formed on the substrate by the TFT process, and the light-emitting portion, such as an organic EL element or the like, is laminated on the transistor portion and the capacitor portion. A transparent counter substrate is attached onto the light-emitting portion by an adhesive, obtaining a flat panel.

As shown in FIG. 20, the display device according to each embodiment of the invention includes one having a flat module shape. For example, pixels each having an organic EL element, thin film transistors, thin film capacitors, and the like are laminated on an insulating substrate in a matrix, providing a pixel array section. An adhesive is disposed so as to surround the pixel array section (pixel matrix section), and a counter substrate made of glass or the like is attached, obtaining a display module. If needed, color filters, a protective film, a light-shielding film, and the like may be provided on the transparent counter substrate. The display module may be provided with an FPC (Flexible Print Circuit) serving as a connector for input/output of signals or the like from the outside and the pixel array section.

The above-described display device according to each embodiment of the invention has a flat panel shape, and may be applied to various electronic apparatuses, for example, digital cameras, notebook-type personal computers, cellular phones, video cameras, and the like. The display device according to each embodiment of the invention may be applied for a display of an electronic apparatus which displays a drive signal input to or generated by the electronic apparatus as an image or video. Hereinafter, examples of electronic apparatuses to which such a display device is applied will be described. An electronic apparatus basically includes a main body which processes information, and a display unit which displays information input to the main body or information output from the main body.

FIG. 21 shows a television to which the invention is applied. The television includes a video display screen 11 having a front panel 12, a filter glass 13, and the like. The television is manufactured by using the display device according to each embodiment of the invention for the video display screen 11.

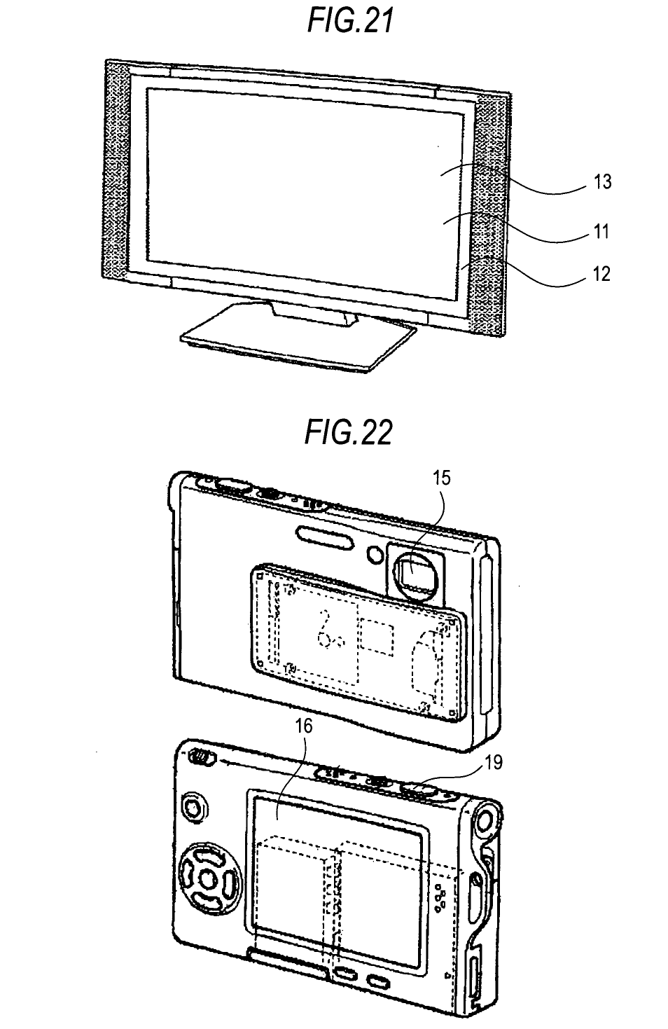

FIG. 22 shows a digital camera to which the invention is applied. In FIG. 22, the upper side is a front view and the lower side is a rear view. The digital camera includes an imaging lens, a light-emitting portion 15 for flash, a display unit 16, a control switch, a menu switch, a shutter 19, and the like. The digital camera is manufactured by using the display device of each embodiment of the invention for the display unit 16.

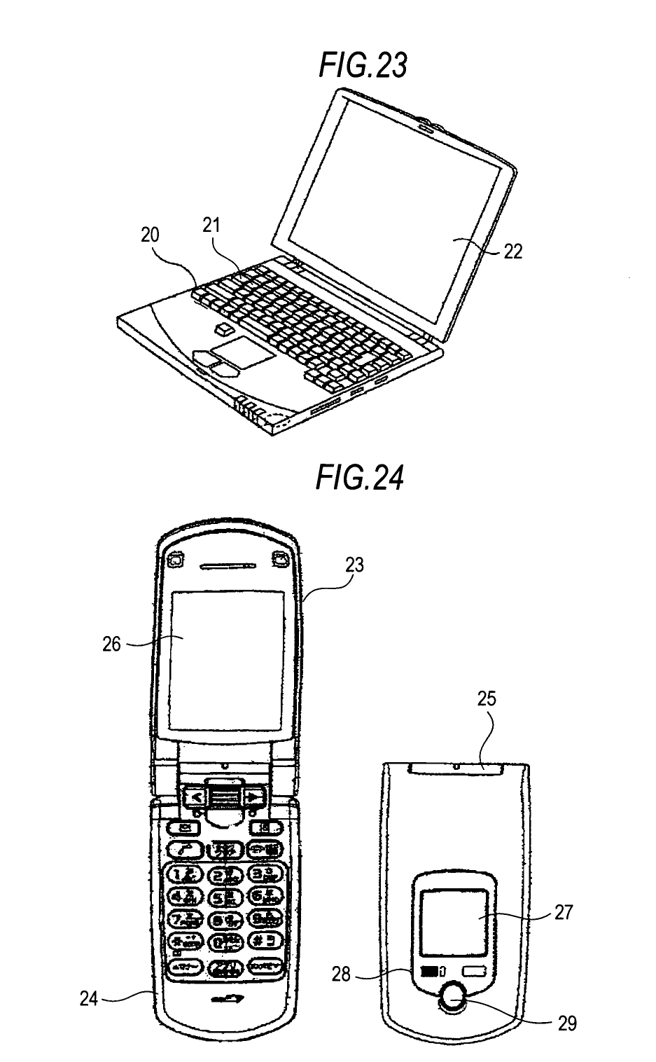

FIG. 23 shows a notebook-type personal computer to which the invention is applied. The notebook-type personal computer includes a keyboard 21 which is provided in a main body 20 and is operated when the user inputs characters or the like, and a display unit 22 which is provided in a main body cover to display an image. The notebook-type personal computer is manufactured by using the display device according to each embodiment of the invention for the display unit 22.

FIG. 24 shows a personal digital assistant to which the invention is applied. In FIG. 24, the left side shows an unfolded state and the right side shows a folded state. The personal digital assistant includes an upper casing 23, a lower casing 24, a connection portion (in this case, a hinge) 25, a display 26, a sub display 27, a picture light 28, a camera 29, and the like. The personal digital assistant is manufactured by using the display device according to each embodiment of the invention for the display 26 or the sub display 27.

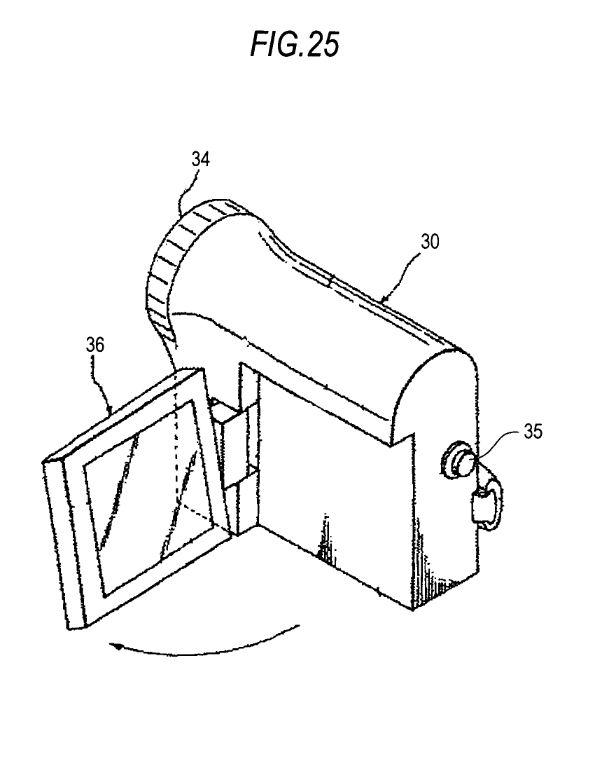

FIG. 25 shows a video camera to which the invention is applied. The video camera includes a main body portion 30, a lens 34 for photographing a subject at the forward side surface, a photographing start/stop button 35, a monitor 36, and the like. The video camera is manufactured by using the display device according to each embodiment of the invention for the monitor 36.

The present application contains subject matter related to that disclosed in Japanese Priority Patent Application JP 2008-317772 filed in the Japan Patent Office on Dec. 15, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a screen section;
a drive section; and
a signal processing section,
wherein the screen section includes scanning lines arranged in rows, signal lines arranged in columns, and pixel circuits arranged in a matrix,
the drive section includes a scanner which supplies a control signal to the scanning lines, and a driver which supplies a video signal to the signal lines,
each of the pixel circuits includes a light-emitting element, a light-receiving element, and a drive transistor,
the drive transistor outputs a drive current in response to the video signal and outputs a correction current in response to a luminance signal,
the light-emitting element emits light in accordance with the drive current,
the light-receiving element outputs the luminance signal in accordance with the light-emission, and
the signal processing section corrects the video signal in accordance with the correction current and supplies the corrected video signal to the driver.

2. The display device according to claim 1,
wherein the drive transistor has a gate to which the video signal and the luminance signal are applied,
the light-emitting element is connected to one of the drain and source of the drive transistor, and
the light-receiving element is connected to the gate of the drive transistor.

3. The display device according to claim 2,
wherein the pixel circuit includes
a first transistor connected to the gate of the drive transistor,
a second transistor connected to one of the drain and source of the drive transistor, and
a capacitor connected between one of the drain and source of the drive transistor and the gate of the drive transistor.

4. The display device according to claim 3,
wherein the pixel circuit further includes
a third transistor connected between the drive transistor and the light-emitting element, and
a fourth transistor connected between a signal line of a pixel circuit adjacent to the pixel circuit and the light-emitting element of the pixel circuit.

5. The display device according to claim 3,
wherein the pixel circuit further includes
a third transistor connected between the drive transistor and the light-emitting element, and
a fourth transistor connected between the driver and the light-emitting element of the pixel circuit.

6. The display device according to claim 1,
wherein the drive transistor of the pixel circuit operates during a light-emission period and a light-reception period, and
the drive transistor outputs the drive current during the light-emission period and outputs correction current in accordance with the light-emission of a different pixel circuit during the light-reception period.

7. The display device according to claim 6,
wherein the different pixel circuit is a pixel circuit adjacent to the pixel circuit.

8. The display device according to claim 1,
wherein the drive transistor of the pixel circuit operates during a light-emission period and a light-reception period, and
the drive transistor outputs the drive current during the light-emission period and outputs the correction current in accordance with the light-emission of the pixel circuit during the light-reception period.

9. The display device according to claim 8,
wherein, during the light-reception period, the light-emitting element of the pixel circuit emits light due to a current supplied from the driver, and the light-receiving element of the pixel circuit outputs the luminance signal in accordance with the light-emission.

10. The display device according to claim 1,
wherein the drive transistor supplies the correction current to the relevant signal line, and
the signal processing section corrects the video signal in accordance with the correction current and supplies the corrected video signal to the driver of the drive section.

11. The display device according to claim 1,
wherein the signal processing section compares a first correction current output from the drive transistor during a first period with a second correction current output from the drive transistor during a second period later than the first period, corrects the video signal in accordance with the comparison result, and supplies the corrected video signal to the driver.

12. An electronic apparatus comprising the display device according to claim 1.

13. A method of driving a display device, the display device including a screen section, a drive section, and a signal processing section, the screen section including scanning lines arranged in rows, signal lines arranged in columns, and pixel circuits arranged in a matrix, the drive section including a scanner which supplies a control signal to the scanning lines, and a driver which supplies a video signal to the signal lines, and each of the pixel circuits including a light-emitting element, a light-receiving element, and a drive transistor, the method comprising the steps of:
causing the drive transistor to output a drive current in response to the video signal and to output a correction current in response to a luminance signal;
causing the light-emitting element to emit light in accordance with the drive current;
causing the light-receiving element to output the luminance signal in accordance with the light-emission; and
causing the signal processing section to correct the video signal in accordance with the correction current and to supply the corrected video signal to the driver.
